(19) United States
(12) Patent Application Publication
(10) Pub. No.: US 2009/0291333 A1
(43) Pub. Date: Nov. 26, 2009

(54) REACTION PRODUCT CONTROL SYSTEM AND PROCESS FOR CONTROLLING A REACTION PRODUCT IN A FUEL CELL

(75) Inventor: Timothy LaBreche, Ann Arbor, MI (US)

Correspondence Address: Adaptive Materials Inc., 5500 S. State Rd., Ann Arbor, MI, 48108, US

(73) Assignee: Adaptive Materials Inc., Ann Arbor, MI (US)

(21) Appl. No.: 12/126,327

(22) Filed: May 23, 2008

(51) Int. Cl. H01M 8/00; H01M 8/04

(52) U.S. Cl. 429/13; 429/22

(57) ABSTRACT

A reaction product control system for a fuel cell that includes a controller and a fuel mass flow sensor linked with the controller. An oxidant mass flow sensor is also linked with the controller. Fuel and oxidant control devices are linked with the controller. A fuel and oxidant react to form a reaction product. The fuel mass flow sensor is calibrated for a fuel at an oxidant flow rate and the controller then automatically adjusts the fuel control device when the fuel changes composition to produce the desired reaction product.

### FIELD OF THE INVENTION

The invention relates to reaction product control systems and with more particularity to reaction product control systems for a fuel cell.

### BACKGROUND OF THE INVENTION

Fuel cell systems generally include mass flow controllers for regulating an amount of fuel and air that enters a fuel cell. Typically, such mass flow controllers are calibrated for detecting the flow rate of a given reactant. Such mass flow controllers generally will not work with a fuel source containing mixed reactants as it has not been properly calibrated for more than one reactant. Additionally, if a new reactant or different reactant was to be used by a fuel cell, the mass flow controller would need to be recalibrated for use with a different fuel requiring numerous recalibrations when a fuel source is changed.

There is therefore a need in the art for a reaction product controller that does not require recalibration for a number of different fuel and oxidant sources. There is also a need in the art for a process for controlling a reaction product that does not require calibration for different types of fuels and oxidants.

### SUMMARY OF THE INVENTION

In one aspect, there is disclosed a reaction product control system for a fuel cell that includes a controller and a fuel mass flow sensor linked with the controller. An oxidant mass flow sensor is also linked with the controller. Fuel and oxidant control devices are linked with the controller. A fuel and oxidant react to form a reaction product. The fuel mass flow sensor is calibrated for a fuel at an oxidant flow rate and the controller then automatically adjusts the fuel control device when the fuel changes composition to produce the reaction product.

In another aspect, there is disclosed a reaction product control system for a fuel cell that includes a controller and a fuel mass flow sensor linked with the controller. An oxidant mass flow sensor is also linked with the controller. Fuel and oxidant control devices are linked with the controller. Fuel having a ratio of carbon to hydrogen and oxidant react to form a reaction product. The fuel mass flow sensor is calibrated for a fuel at an oxidant flow rate and the controller then automatically adjusts the fuel control device when the fuel changes composition to produce the reaction product having a desired ratio of carbon to hydrogen.

In another aspect, there is disclosed a process for controlling a reaction product in a fuel cell that includes the steps of: providing a controller; providing fuel and oxidant mass flow sensors; providing a fuel and an oxidant that react forming a reaction product; calibrating the fuel mass flow sensor for a first fuel at a first oxidant flow; outputting a signal from the fuel mass flow sensor to the controller; compiling the signals of the mass controller for a plurality of oxidant flow rates; and automatically adjusting the fuel flow of a second fuel for an oxidant flow rate wherein the reaction product is maintained.

In another aspect, there is disclosed a process for controlling a reaction product in a fuel cell that includes the steps of: providing a controller; providing fuel and oxidant mass flow sensors; providing a fuel and an oxidant that react forming a reaction product; calibrating the fuel mass flow sensor for a first fuel at a first oxidant flow; outputting a signal from the fuel mass flow sensor to the controller; compiling the signals of the fuel mass flow sensor for a plurality of oxidant flow rates; and automatically adjusting the fuel flow of a second fuel for an oxidant flow rate wherein the reaction product is maintained having a desired ratio of carbon to hydrogen.

### BRIEF DESCRIPTION OF THE DRAWINGS

FIG. 1A is a schematic representation of a fuel cell including a mass flow controller and fuel and oxidant streams entering the fuel cell;

FIG. 1B is a schematic representation of a fuel cell including a mass flow controller and fuel and oxidant streams entering the fuel cell;

FIG. 2 is a plot of the fuel sensor output versus the number of carbons for a partial oxidation reaction;

FIG. 3 is a plot of the flow rate of fuel versus different fuel mixtures or blends;

FIG. 4 is a plot of the composition of the various fuel mixture or blends of FIG. 3;

FIG. 5 is a plot of the power and temperature in a fuel cell as a function of time for two fuel sources that are changed during operation of the fuel cell;

FIG. 6 is a schematic representation of an alternate arrangement of a fuel cell including a mass flow controller and fuel and oxidant streams entering the fuel cell.

### DETAILED DESCRIPTION OF THE PREFERRED EMBODIMENTS

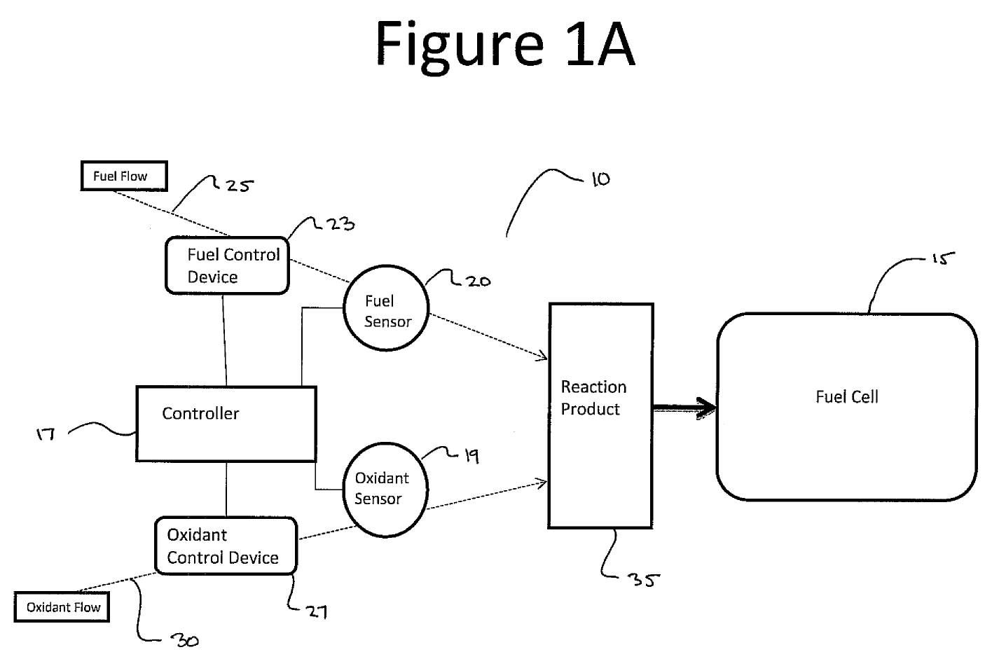

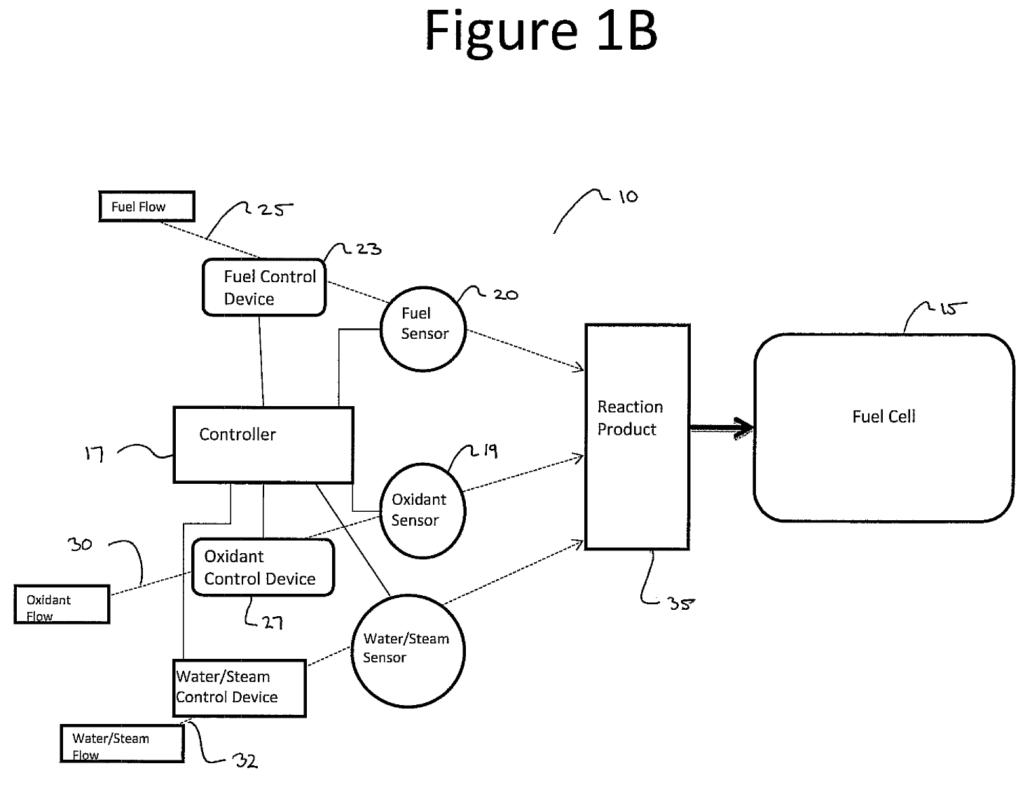

Referring to FIG. 1A, there is shown a schematic representation of a reaction product control system 10 and fuel cell 15, for example a solid oxide fuel cell including a controller 17 linked with a fuel mass flow sensor 20 and fuel control device 23. The controller 17 may also be linked with an oxidant mass flow sensor 19 and an oxidant control device 27. The control devices 23, 27 may be valves or other controllable orifices that may be adjusted to regulate a flow of either a fuel or oxidant stream 25, 30. The fuel and oxidant streams 25, 30 react to form a reaction product 35 for use as a fuel source in the fuel cell 15. The fuel mass flow sensor 20 is calibrated for a single fuel and an oxidant flow rate to produce an output signal to the controller 17. The controller 17 then automatically adjusts the fuel control device 23 without re-calibration when the fuel changes composition to produce the desired reaction product 35. In addition, the reaction product controller is capable of maintaining the desired reaction product in the presence of a reasonable amount of impurities and may maintain the reaction product 35 within acceptable error margins or tolerances.

The fuel stream 25 may be a hydrocarbon having the formula C_{X}H_{X+2} that in the presence of a catalyst is reformed with the oxidant 30 to produce the reaction product 35. The hydrocarbon may have from 2 to 20 carbon atoms. The oxidant 30, such as air and oxygen and optionally water 32 as shown in FIG. 1B, may be combined with the fuel stream 25 for various reforming reactions, including partial oxidation, steam reforming and auto thermal reforming reactions. In a reforming reaction, a reactant such as the hydrocarbon is combined with an oxidant in the presence of a catalyst to reform the fuel into a reaction product 35 such as hydrogen and carbon monoxide. The reaction product 35 may be utilized in a fuel cell 15 for an electrocatalytic reaction generating electrical power.

Hydrocarbon fuels such as propane and butane are not directly used in a fuel cell, such as a solid oxide fuel cell, as they may cause carbon deposits or coking within the fuel cell 15. The hydrocarbons are generally reacted with air to farm carbon monoxide and hydrogen by partial oxidation or reacted with water vapor to form hydrogen and carbon dioxide in a steam reforming reaction. Alternatively, the hydrocarbons may be reacted with a combination of air and water vapor to form hydrogen, carbon monoxide, and carbon dioxide. It is necessary to control the fuel to oxidant ratio entering the fuel cell to provide a correct stoichiometry of reaction products with a desired carbon to hydrogen to oxygen ratio. The fuel oxidant stoichiometry is dependent upon the hydrogen and carbon ratio within the fuel source and as stated above in prior art applications often requires calibrations for differing fuel sources or will not work for mixed fuel sources having multiple types of hydrocarbons.

Referring to FIGS. 1A and B, the fuel mass flow sensor 20 may be a differential thermal type device, such as a thermal anemometer or coriolis filowmeter that does not require calibration when a fuel source is changed from one hydrocarbon to another or for a mixed fuel source. Following an initial calibration for one fuel and oxidant, the fuel mass flow sensor 20 will output a signal to the controller 17 which adjusts the fuel control device 23 in a closed feedback loop with the fuel mass flow sensor 20 to automatically compensate to deliver a desired air to fuel ratio for an intended reaction product 35 when the fuel source is changed. This result is unexpected as mass flow sensors generally require calibration to a specific source for measurement. Additionally, no temperature or pressure measurement devices are needed to maintain or regulate the fuel stream to maintain a desired reaction product 35, providing a streamlined and efficient system for controlling a fuel cell 15.

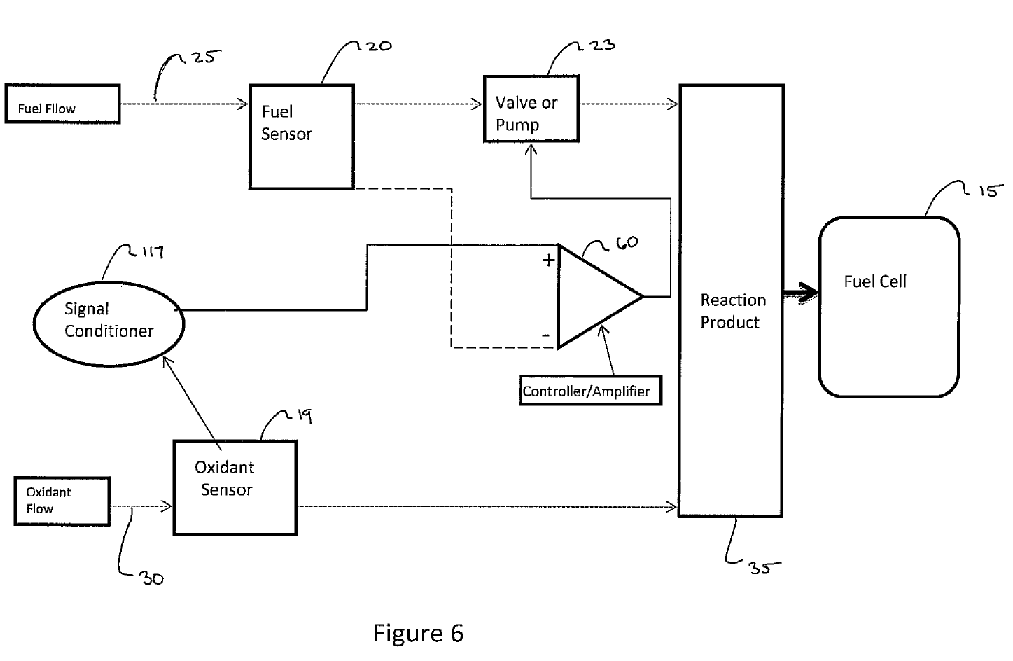

Referring to FIG. 6, there is shown an alternate arrangement of a fuel cell 15 including a controller 17 and fuel and oxidant streams 25, 30 entering tie fuel cell 15. The fuel mass flow sensor 20 may be the same as that described above. However, the arrangement of the controller 17 is de-centralized, lacking a closed loop feedback and is set to a fixed point whose ratio is set by the analog interface between the oxidant mass flow sensor 19, an optional signal conditioner 117, and the fuel mass flow sensor 20. In this manner, following an initial calibration for one fuel and oxidant, the fuel mass flow sensor 20 will output a signal to the amplifier/comparator 60 which adjusts the fuel control device 23 in conjunction with the analog interface of the oxidant mass flow sensor 19, the optional signal conditioner 117, and the fuel mass flow sensor 20 to automatically compensate to deliver a desired air/steam to fuel ratio for an intended reaction product 35 when the fuel source is changed.

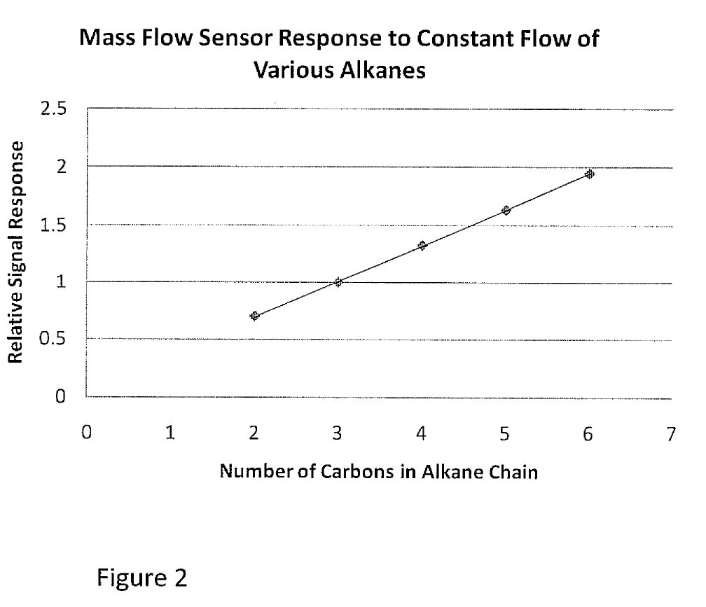

Referring to FIG. 2, there is shown a calibration curve for a reaction product control system 10 with the fuel mass flow sensor output plotted versus the number of carbons in the fuel. The various data points represent alkane fuels having from 2 to 20 carbons. The relative signal responses will change as a result of the number of carbons to form the desired reaction product 35 such as carbon monoxide and hydrogen in a partial oxidation reaction. If the fuel species is changed, the output signal of the fuel mass flow sensor 20 is delivered to the controller 17 which in turn automatically adjusts the flow of another fuel having a different ratio of carbon to hydrogen to produce the desired reaction product 35. In this manner, the reaction product control system 10 maintains the reaction product even though the ratio of oxidant to hydrocarbon has initially changed due to a change in the hydrocarbon fuel.

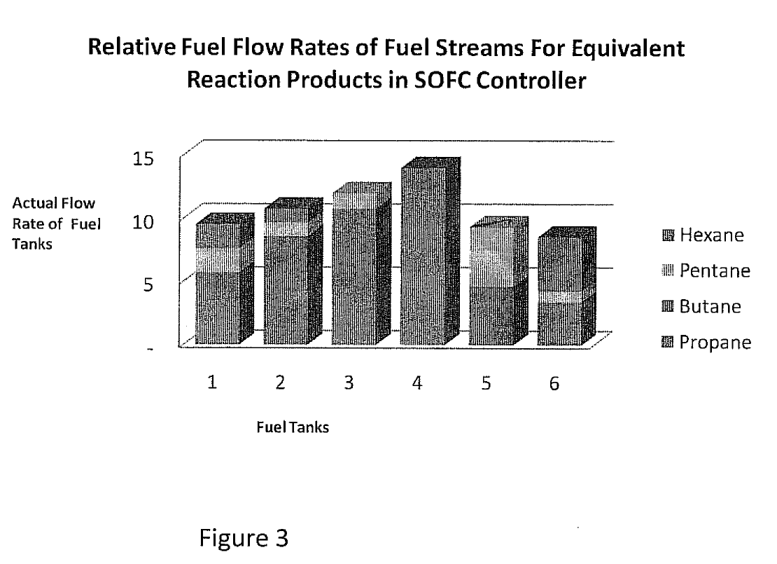

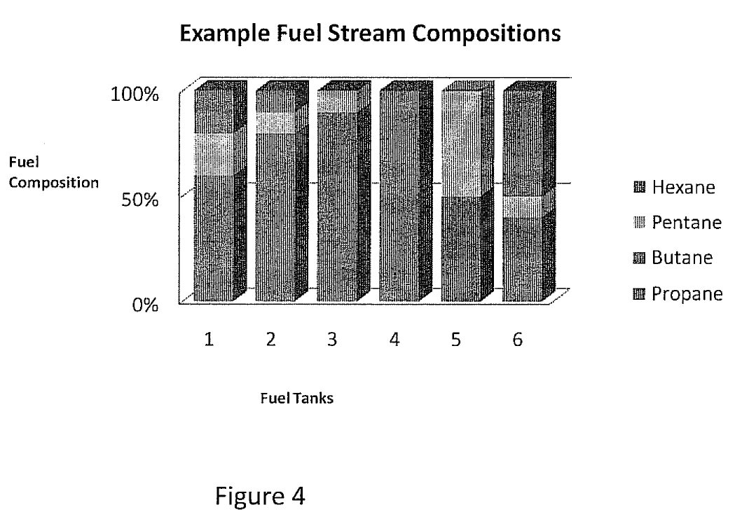

Referring to FIGS. 3 and 4, there are shown plots showing the effect of varying a fuel source composition. As can be seen in FIG. 3, the fuel flow rates of the various fuel sources are different and depend upon the fuel species present to maintain a desired reaction product 35. The compositions of the various fuel sources shown in FIG. 3 and detailed in the plots of FIG. 4 showing the percentages of the various hydrocarbons present in the fuel source. The reaction product control system 10 automatically adjusts the flow rates of different fuels to maintain a desired reaction product.

In another aspect, there is disclosed a method for controlling a reaction product in a fuel cell 15 that includes the steps of providing a controller 17, providing fuel and oxidant mass flow sensors 20, 19, providing a fuel and an oxidant that react forming a reaction product 35, calibrating the fuel mass flow sensor 20 for a first fuel at a first oxidant flow, outputting a signal from the fuel mass flow sensor 20 to the controller 17, compiling the signals of the fuel mass flow sensor 20 for a plurality of oxidant flow rates and automatically adjusting the fuel flow of a second fuel wherein the reaction product is maintained. The process includes the step of maintaining a desired ratio of the fuel to the oxidant such that a desired ratio of carbon to hydrogen to oxygen is maintained. In other words, the desired ratio of fuel to oxidant produces a desired reaction product.

As can be seen from the above description, the reaction product control system 10 and process maintains a desired reaction product 35 from an input of a fuel and oxidant wherein the fuel and oxidant flow rates may change and a fuel may change from one type to another In this manner, recalibration of a fuel mass flow sensor for a different fuel may be avoided. The reaction product control system 10 automatically adjusts the fuel flow rate of the fuel source when it is changed from one source to another. The fuel sources may have a different ratio of carbon to hydrogen and the reaction product is maintained.

In another aspect, the ratio between fuel and oxidant delivered from the reaction product control system 10 may be adjusted to control various parameters of the operation of the fuel cell 15. For example, during start-up of the fuel cell changes in the ratio of fuel to oxidant may be adjusted to provide in situ heating of the fuel cell 15. The change in the fuel to oxidant ratio may be designed to increase the fraction of oxidant to fuel to maximize the thermal energy liberated. The increased fraction of oxidant can vary between a perfect ratio of fuel to oxidant for a partial oxidation reaction or for a perfect combustion reaction wherein all of the fuel is burned or in some cases a lean mixture of oxidant and fuel having extra oxidant to ensure complete combustion may be utilized. In this manner the degree of reaction of the fuel and oxidant may be regulated for the fuel cell 15 to maintain desired operating parameters for the fuel cell 15.

Adjusting the ratio of fuel and oxidant can also be employed to assist in the control of an operating temperature of the fuel cell 15. The ratio of oxidant to fuel can be varied to adjust the thermal energy released during reforming. Additional oxidant may serve to increase the local temperature in and around the reforming reactor. Subtracting air reduces the thermal energy released during partial oxidation or auto-thermal reforming in the fuel cell 15.

During steam reforming the relative amount of water (in liquid or vapor form) can be varied to adjust the thermal conditions in and/or around the reactor. For example an increase in the water will result in a colder temperature and a decrease in the amount of water will result in an increased temperature.

### EXAMPLES

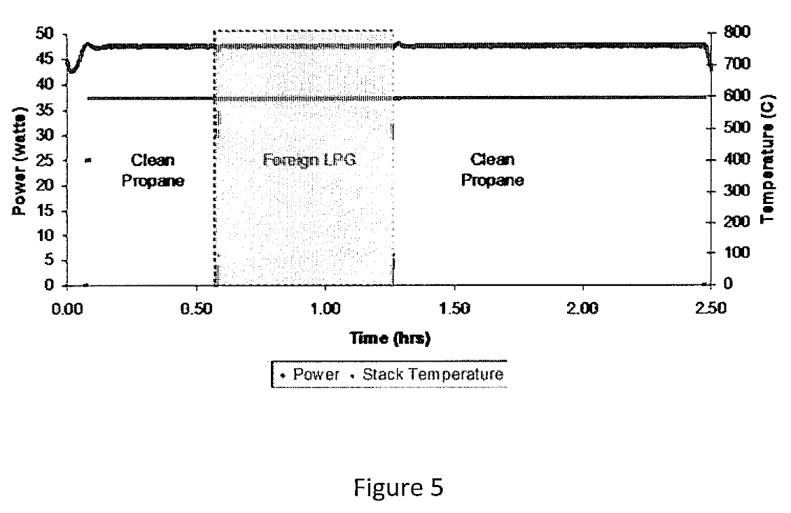

A solid oxide fuel cell is coupled to a reaction product control system 10 and fuel source as represented in FIG. 1. A measurement device is connected to the fuel cell to measure a power and temperature of the fuel cell as the fuel sources are changed during operation of the fuel cell. Referring to FIG. 5 there is shown a plot of the power and temperature of a fuel cell for a propane fuel source and a mixed fuel source of 70 percent propane and 30 percent butane. The fuel cell at time zero is coupled to the propane fuel source and had power and temperature values as shown by the data points and lines indicated in the plot. At approximately 0.6 hours, the propane fuel source was switched to the mixed fuel source of propane and butane. The power and temperature have data points that quickly resume after a transition to the constant line of data points as previously displayed for the propane fuel. Again at approximately 1.25 hours the fuel source is changed back to propane and the data points for the power and temperature quickly resume after a transition to the constant line of data points as previously displayed for the propane and butane fuel and the previous propane fuel. This similarity in plots of the power and temperature verifies that the reaction product control system 10 automatically adjusts the fuel control device and the reaction product when the fuel sources are changed to produce the same power output in the fuel cell.

1. A reaction product control system for a fuel cell comprising:
a controller;
a fuel mass flow sensor linked with the controller;
an oxidant mass flow sensor linked with the controller;
a fuel control device linked with the controller;
an oxidant control device linked with the controller;
a fuel and an oxidant reacting to form a reaction product;
wherein the fuel mass flow sensor is calibrated for a fuel at an oxidant flow rate and the controller then automatically adjusts the fuel control device and oxidant control device when the fuel changes composition to produce the reaction product.

2. The reaction product control system of claim 1 wherein the fuel mass flow sensor is selected from: thermal anemometer and coriolis flowmeter.

3. The reaction product control system of claim 1 where in the fuel is a C2 to C20 alkane.

4. The reaction product control system of claim 1 wherein the fuel is a mixture of C2 to C20 alkanes.

5. The reaction product control system of claim 1 wherein the oxidant is selected from air, water, and oxygen.

6. The reaction product control system of claim 1 wherein the fuel and oxidant react forming the reaction product containing carbon monoxide and hydrogen.

7. The reaction product control system of claim 1 wherein the fuel and oxidant react forming the reaction product containing carbon dioxide and hydrogen.

8. A reaction product control system for a fuel cell comprising:
a controller;
a fuel mass flow sensor linked with the controller;
an oxidant mass flow sensor linked with the controller;
a fuel control device linked with the controller;
an oxidant control device linked with the controller;
a fuel having a ratio of carbon to hydrogen and an oxidant reacting to form a reaction product;
wherein the fuel mass flow sensor is calibrated for a fuel at an oxidant flow rate and the controller then automatically adjusts the fuel control device when the fuel changes composition to produce the reaction product having a desired ratio of carbon to hydrogen.

9. A process for controlling a reaction product in a fuel cell comprising the steps of:
a) providing a controller;
b) providing fuel and oxidant mass flow sensors;
c) providing a fuel and an oxidant that react forming a reaction product;
d) calibrating the fuel mass flow sensor for a first fuel at a first oxidant flow;
e) outputting a signal from the fuel mass flow sensor to the controller;
f) compiling the signals of the mass controller for a plurality of oxidant flow rates;
g) automatically adjusting the fuel flow of a second fuel for an oxidant flow rate wherein the reaction product is maintained.

10. The process of controlling a reaction product in a fuel cell of claim 9 wherein the fuel mass flow sensor is selected from: thermal anemometer and coriolis flowmeter.

11. The process of controlling a reaction product in a fuel cell of claim 9 including the step of maintaining a desired ratio of the fuel to the oxidant.

12. The process of controlling a reaction product in a fuel cell of claim 9 including the step of maintaining a desired ratio of carbon to hydrogen to oxygen.

13. The process of controlling a reaction product in a fuel cell of claim 9 including the step of adjusting the ratio of fuel to oxidant to obtain a desired operating condition of the fuel cell.

14. The process of controlling a reaction product in a fuel cell of claim 13 wherein the ratio of fuel to oxidant is adjusted to regulate the temperature of the fuel cell.

15. The process of controlling a reaction product in a fuel cell of claim 13 wherein the ratio of fuel to oxidant is adjusted to regulate the degree of reaction between the fuel and oxidant.

16. A process for controlling a reaction product in a fuel cell comprising the steps of:
a) providing a controller;
b) providing fuel and oxidant mass flow sensors;
c) providing a fuel and an oxidant that react forming a reaction product;
d) calibrating the fuel mass flow sensor for a first fuel at a first oxidant flow;
e) outputting a signal from the fuel mass flow sensor to the controller;
f) compiling the signals of the fuel mass flow sensor for a plurality of oxidant flow rates;
g) automatically adjusting the fuel flow of a second fuel for an oxidant flow rate wherein the reaction product is maintained having a desired ratio of carbon to hydrogen.

17. The process of controlling a reaction product in a fuel cell of claim 13 wherein the fuel mass flow sensor is selected from: thermal anemometer and coriolis flowmeter.
